(19) United States
(12) Patent Application Publication
(10) Pub. No.: US 2024/0354776 A1
(43) Pub. Date: Oct. 24, 2024

(54) OPTIMIZATION OF POWER GENERATION AND CONSUMPTION

(71) Applicant: LevelTen Energy, Inc., Seattle, WA (US)

(72) Inventors: Mitchell Reay, Seattle, WA (US); Mike Burghart, Seattle, WA (US); Andrew Bishop, Seattle, WA (US); Rosanne Hoyem, Minneapolis, MN (US)

(73) Assignee: LevelTen Energy, Inc., Seattle, WA (US)

(21) Appl. No.: 18/645,169

(22) Filed: Apr. 24, 2024

Related U.S. Application Data
(60) Provisional application No. 63/497,829, filed on Apr. 24, 2023.

(51) Int. Cl. G06Q 30/018; G06Q 50/06

(52) U.S. Cl. CPC G06Q 30/018; G06Q 50/06

(57) ABSTRACT

In some embodiments, a computer-implemented method of optimizing power management for a consumer is provided. A computing system receives historical power generation and cost information for a plurality of power stations. The computing system receives historical load information for the consumer. The computing system generates an optimal power management strategy based at least on the historical power generation and cost information and the historical load information. The optimal power management strategy includes at least one of a distribution strategy, a storage strategy, or a usage strategy. The computing system causes the consumer to manage power according to the optimal power management strategy.

### CROSS REFERENCE TO RELATED APPLICATION

This application claims the benefit of Provisional Application No. 63/497,829, filed Apr. 24, 2023, the entire disclosure of which is hereby incorporated by reference herein for all purposes.

### BACKGROUND

Climate change is a growing world-wide concern, and many actors are taking any possible steps to reduce the burning of fossil fuels and the resulting greenhouse gas emissions. One way that consumers are reducing their carbon footprint is by switching from purchasing power from power stations that consume fossil fuels to carbon-free sources powered by wind, hydro, and/or solar. However, maximizing the use of carbon-free sources using the existing carbon-free infrastructure faces many difficulties. What is desired are techniques that help increase the availability of carbon-free power to enable goals of consuming power from only carbon-free sources a reality.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method of optimizing power management for a consumer is provided. A computing system receives historical power generation and cost information for a plurality of power stations. The computing system receives historical load information for the consumer. The computing system generates an optimal power management strategy based at least on the historical power generation and cost information and the historical load information. The optimal power management strategy includes at least one of a distribution strategy, a storage strategy, or a usage strategy. The computing system causes the consumer to manage power according to the optimal power management strategy.

In some embodiments, a non-transitory computer-readable medium having computer-executable instructions stored thereon is provided. The instructions, in response to execution by one or more processors of an energy control computing system, cause the energy control computing system to perform actions for optimizing power management for a consumer. The actions comprise receiving, by the energy control computing system, historical power generation and cost information for a plurality of power stations; receiving, by the energy control computing system, historical load information for the consumer; generating, by the energy control computing system, an optimal power management strategy based at least on the historical power generation and cost information for the plurality of power stations and the historical load information for the consumer, wherein the optimal power management strategy includes at least one of a distribution strategy, a storage strategy, or a usage strategy; and causing, by the energy control computing system, the consumer to manage power according to the optimal power management strategy.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic of a non-limiting example embodiment of an electrical power system according to various aspects of the present disclosure.

FIG. 2 is a block diagram that illustrates aspects of a non-limiting example embodiment of a computing system according to various aspects of the present disclosure.

FIG. 3A-FIG. 3B are a flowchart that illustrates a non-limiting example embodiment of a method of optimizing power management according to various aspects of the present disclosure.

### DETAILED DESCRIPTION

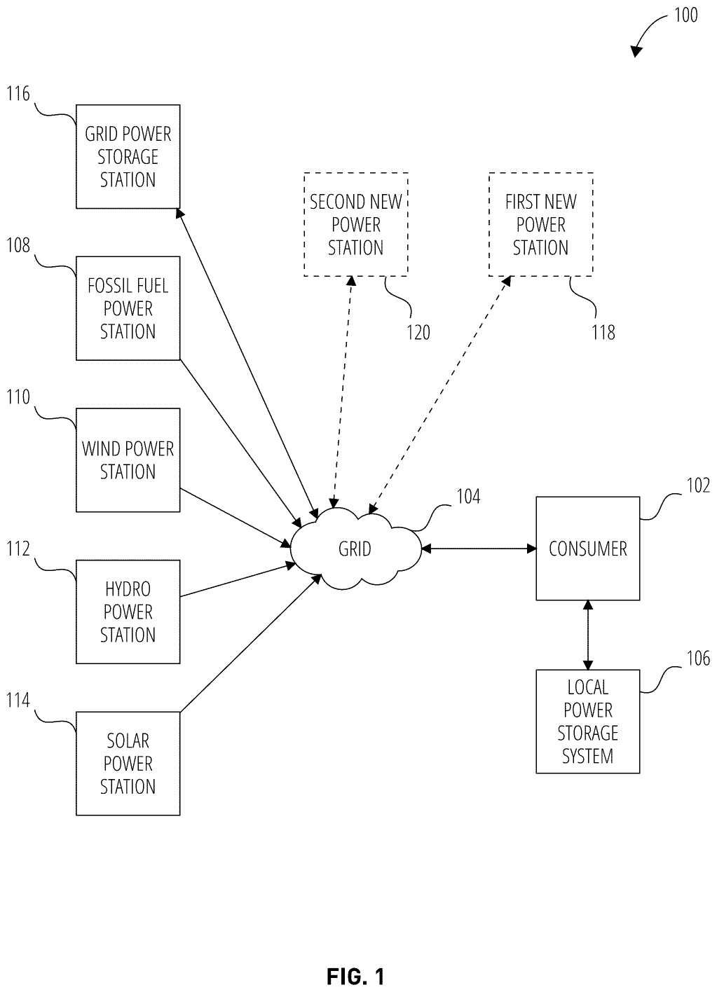

In the modern electrical power system, power is typically generated by power stations, and distributed to consumers via an electrical grid and/or via direct transmission to the consumers. FIG. 1 is a schematic of a non-limiting example embodiment of an electrical power system according to various aspects of the present disclosure. As shown, the electrical power system 100 includes various types of power stations that provide power to a grid 104 for distribution to consumers, such as consumer 102.

The figure illustrates a fossil fuel power station 108 (such as a coal-powered power station or a natural gas-powered power station), a wind power station 110, a hydro power station 112, and a solar power station 114 as example types of power stations that may provide power to the grid 104. Naturally, in some embodiments, multiple power stations of a given type may be connected to the grid 104, and more, fewer, or different types of power stations may be present.

In some embodiments, some types of power stations (such as grid power storage station 116) may be connected in a bi-directional manner to the grid 104, such that at some times the power station may consume power from the grid 104, while at other times, the power station may provide power to the grid 104. In some embodiments, such grid power storage functionality may be integrated into another type of power station. Such power storage can be helpful in evening out supply levels from power stations that provide fluctuating generation capacity, including but not limited to wind power station 110 and solar power station 114.

In some embodiments, the consumer 102 may be able to decide which power stations will be used to provide power to the consumer 102, and the grid 104 may provide the power from the selected power stations to the consumer 102. This allows the consumer 102 to attempt to optimize their purchasing of power to serve one or more goals of the consumer 102, including but not limited to cost reduction (e.g., purchasing power from less expensive power stations instead of more expensive power stations) or environmental impact reduction (e.g., purchasing power from green energy power stations instead of conventional power stations). The consumer 102 may also use local power storage system 106 to help this optimization, as the price and availability of power provided by the power stations and the grid 104 may fluctuate over time due to a variety of factors. The consumer 102 may store power from the grid 104 in local power storage system 106 at times when power is inexpensive or in surplus, and may consume power from local power storage system 106 instead of or in addition to consuming power from the grid 104 at times when power is expensive or is unavailable to meet the demand of the consumer 102.

In addition to the existing power stations already present and connected to the grid 104, entrepreneurs may propose the construction of new power stations, such as first new power station 118 and second new power station 120. While these power stations may not yet be fully constructed or functional, consumer 102 may enter into agreements with the operators of the new power stations to help finance their construction, and to include such new power stations in the long-term planning for power purchasing by the consumer 102.

As noted above, one way that consumers 102 are reducing their carbon footprint is by switching from purchasing power from fossil fuel power stations 108 to carbon-free sources such as wind power stations 110, hydro power stations 112, and solar power stations 114. However, some consumers 102 have set goals of using only carbon-free energy (“CFE”) at all times (twenty-four hours a day, and seven days a week, or a 24/7 CFE goal), and meeting this goal using existing carbon-free sources is difficult.

One problem is that many CFE sources such as solar power stations 114 and wind power stations 110 are subject to varying capacity due to weather, seasons, time of day, and other factors. As such, meeting load demand for a given consumer 102 if the load demand does not track the hourly capacity may not be possible from these sources without significant investments in grid power storage stations 116 or local power storage system 106. Another problem is that since CFE capacity is still growing, it is possible that enough existing capacity may not be available to meet demand from consumers 102. Accordingly, incentivizing the development of new CFE sources such as first new power station 118 and second new power station 120 is desirable. Finally, the planning of power purchases from a variety of carbon-free sources on an hour-by-hour basis is extraordinarily complex given the variety of hourly rates, hourly capacities, and multiplicity of both existing power stations and potentially planned power stations, particularly if efficient use of capital is a desired outcome, and is impractical (if not impossible) to be performed mentally by a human planner. What is desired are automatic techniques for determining optimal power management in order to maximize generation and obtaining of power from carbon-free power stations and for planning and utilizing deployment of local power storage system 106 in order to meet 24/7 CFE goals.

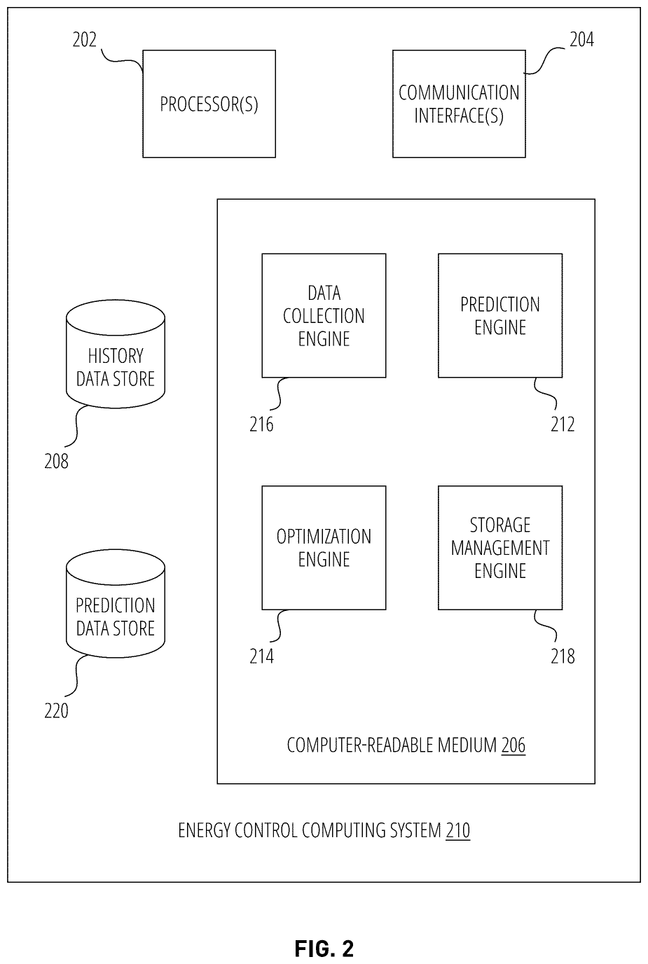

FIG. 2 is a block diagram that illustrates aspects of a non-limiting example embodiment of an energy control computing system 210 according to various aspects of the present disclosure. The illustrated energy control computing system 210 may be implemented by any computing device or collection of computing devices, including but not limited to a desktop computing device, a laptop computing device, a mobile computing device, a server computing device, a computing device of a cloud computing system, and/or combinations thereof. In some embodiments, the energy control computing system 210 is configured to collect information about power stations accessible to a consumer 102 (including potential future power stations under development), to determine (and potentially implement) an optimal strategy for managing power, including a strategy for obtaining power from the power stations, and to determine (and potentially implement) an optimal strategy for managing local power storage system 106 to complement the optimal strategy for obtaining power from the power stations.

As shown, the energy control computing system 210 includes one or more processors 202, one or more communication interfaces 204, a history data store 208, and a computer-readable medium 206.

In some embodiments, the processors 202 may include any suitable type of general-purpose computer processor. In some embodiments, the processors 202 may include one or more special-purpose computer processors or AI accelerators optimized for specific computing tasks, including but not limited to graphical processing units (GPUs), vision processing units (VPUs), and tensor processing units (TPUs).

In some embodiments, the communication interfaces 204 include one or more hardware and or software interfaces suitable for providing communication links between components. The communication interfaces 204 may support one or more wired communication technologies (including but not limited to Ethernet, Fire Wire, and USB), one or more wireless communication technologies (including but not limited to Wi-Fi, WiMAX, Bluetooth, 2G, 3G, 4G, 5G, and LTE), and/or combinations thereof.

As shown, the computer-readable medium 206 has stored thereon logic that, in response to execution by the one or more processors 202, cause the energy control computing system 210 to provide a data collection engine 216, a prediction engine 212, an optimization engine 214, and a storage management engine 218.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

In some embodiments, the data collection engine 216 is configured to collect hourly cost, capacity and other data from power stations accessible to the consumer 102 (and/or power stations under development for future access by the consumer 102). The data collection engine 216 may also collect past climate, weather, or other information (or predictions of future climate, weather, or other information) that may have impacted (or will impact) the cost, capacity, and other data from the power stations. The data collection engine 216 may also collect information regarding the hourly demand generated by the consumer 102. The data collection engine 216 may store information that it collects in the history data store 208.

In some embodiments, the prediction engine 212 is configured to generate future predictions of hourly cost, capacity, and other data for the power stations, based on the historical data stored in the history data store 208. In some embodiments, the optimization engine 214 is configured to calculate an optimal strategy for obtaining power from the power stations based on the predictions generated by the prediction engine 212, and potentially to cause the strategy to be implemented to provide power to the consumer 102. The optimization engine 214 may also be configured to generate a strategy for deploying, charging, and/or discharging the local power storage system 106 to complement the optimal strategy for obtaining power, and may provide the strategy to the storage management engine 218 for implementation. The optimization engine 214 may also be configured to generate a strategy for using power obtained from the power stations and the local power storage system 106, and may cause the strategy for using power to be implemented by the consumer 102.

Further description of the configuration of each of these components is provided below.

As used herein, “engine” refers to logic embodied in hardware or software instructions, which can be written in one or more programming languages, including but not limited to C, C++, C#, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

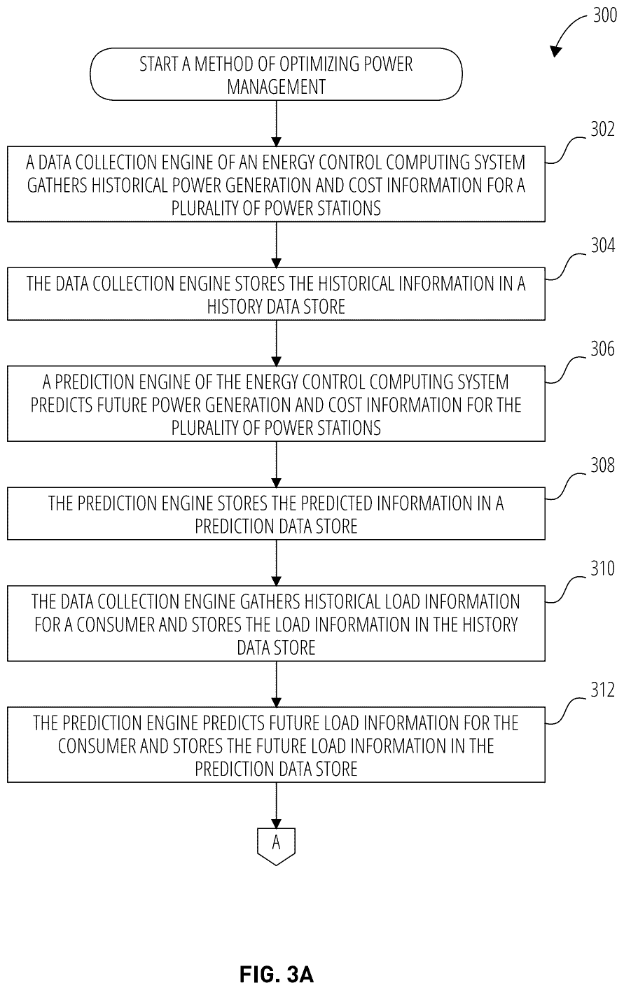

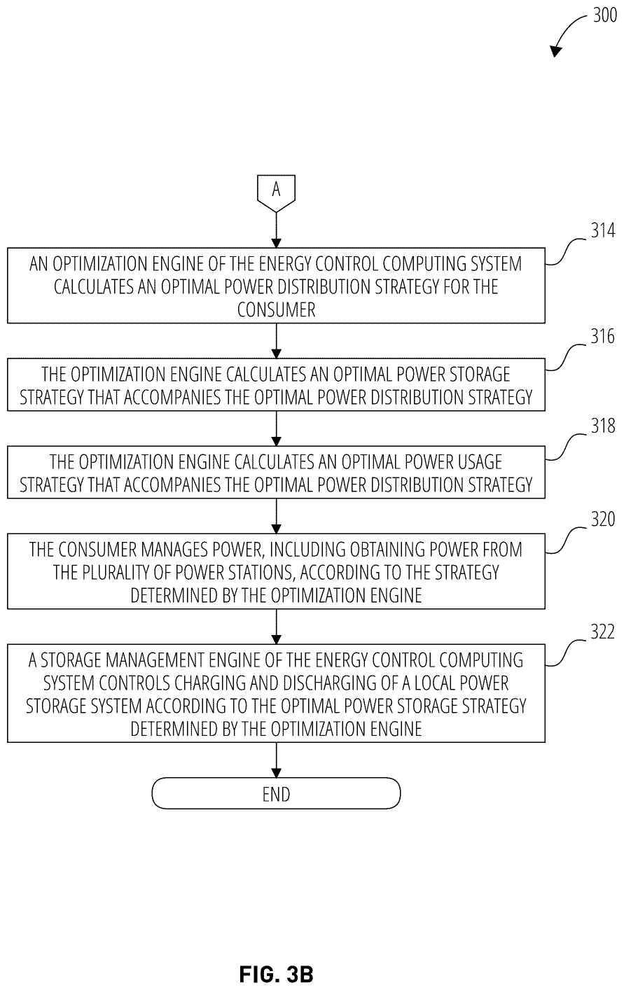

FIG. 3A-FIG. 3B are a flowchart that illustrates a non-limiting example embodiment of a method of optimizing power management according to various aspects of the present disclosure.

From a start block, the method 300 proceeds to block 302, where a data collection engine 216 of an energy control computing system 210 gathers historical power generation and cost information for a plurality of power stations. In some embodiments, the historical power generation and cost information includes, for each power station, an hour-by-hour indication of an amount of power generated and an hour-by-hour indication of a price charged per unit of power generated.

While the amount of power generated and priced charged may be relatively stable for some types of power stations (such as fossil fuel power stations 108), other types of power stations (such as wind power stations 110 and/or solar power stations 114) may have fluctuating capacity and price throughout the course of a day, over a year, etc. due to changing weather conditions, changing amounts of solar energy available, etc. In some embodiments, the information may include an actual amount of power generated in each hour. In some embodiments, the information may include a capacity for power generated in each hour regardless of the actual amount of power generated, which may be useful in situations where power stations provide less than their rated capacity at a given time to prevent a surplus of power being supplied to the grid 104.

At block 304, the data collection engine 216 stores the historical information in a history data store 208. By storing the historical information in the history data store 208, the data collection engine 216 is able to build a repository of information that can be useful in generating multiple strategies for optimizing power distribution with respect to different goals.

At block 306, a prediction engine 212 of the energy control computing system 210 predicts future power generation and cost information for the plurality of power stations. In some embodiments, the prediction engine 212 may use weather predictions, climate predictions, load predictions for the grid 104, or any other suitable information to generate hour-by-hour predictions of power generated and the cost of the generation. In some embodiments, the predictions may include amounts of power actually generated, and/or may include capacity for power generation regardless of the amounts of power actually generated.

At block 308, the prediction engine 212 stores the predicted information in a prediction data store 220. Storing the predicted information allows for repeated generation of optimized strategies from a consistent prediction dataset, thus allowing for apples-to-apples comparison of various optimization results. Further, storing the predicted information instead of repeatedly generating the predictions for each optimization saves processing time without significantly impacting the accuracy of the optimization results.

At block 310, the data collection engine 216 gathers historical load information for a consumer 102 and stores the load information in the history data store 208. As with the other historical information, this may be provided on an hour-by-hour basis, or with even greater granularity.

At block 312, the prediction engine 212 predicts future load information for the consumer 102 and stores the future load information in the prediction data store 220. In some embodiments, the prediction of future load information may be based on at least the historical load information. In some embodiments, the prediction of future load information may be further informed by planned changes at the consumer 102 (e.g., addition of further equipment to be powered, changes in operating hours or the flexibility thereof, etc.) as provided by the consumer 102 to the prediction engine 212.

The method 300 then proceeds to a continuation terminal (“terminal A”). From terminal A (FIG. 3B), the method 300 proceeds to block 314, where an optimization engine 214 of the energy control computing system 210 calculates an optimal power distribution strategy for the consumer 102. At block 316, the optimization engine 214 calculates an optimal power storage strategy that accompanies the optimal power distribution strategy. At block 318, the optimization engine 214 calculates an optimal power usage strategy that accompanies the optimal power distribution strategy.

The optimization engine 214 may use any suitable optimization technique to solve the optimization problem of choosing power stations to provide energy to the consumer 102. A goal of the optimization is to maximize an amount of carbon-free energy (CFE) obtained by a consumer 102 on an hour-by-hour basis while minimizing a cost to the consumer 102 of the energy obtained. The optimization engine 214 receives a variety of inputs, and determines a variety of outputs that maximize a value of an objective function that represents the goals of the optimization. Any suitable optimization technique may be used by the optimization engine 214, including but not limited to a mixed integer linear programming solver.

Any suitable inputs that represent relevant variables for the optimization may be provided to the optimization engine 214. For example, exogenous time series inputs that represent load generated by the consumer 102, a mix of power stations connected to the grid 104, power production profiles by technology (e.g., profiles for variable renewable energy (VRE) or intermittent renewable energy sources (IRES) such as wind power stations 110, solar power stations 114; profiles for dispatchable energy sources such as hydro power stations 112, geothermal power stations, biomass power stations; etc.), and historical or forecasted locational marginal pricing (LMP) values may be provided as input to the optimization engine 214. These time series inputs may be provided on an hour-by-hour basis for an amount of time over which the optimization engine 214 runs, such as over a year (8760 hours).

Additional inputs may also be provided to the optimization engine 214. In some embodiments, inputs that represent specific characteristics of a given power generation technology or power station may be provided. For example, inputs that represent a power purchasing agreement (PPA) price, a maximum power generation capacity, and/or a LMP node/hub may be provided. As additional examples, inputs that represent a duration, a maximum of annual charge/discharge cycles, a discharge/charge efficiency, a starting state of energy (SoE), or other inputs may be used to represent factors relating to grid power storage stations 116 or local power storage systems 106. Further, inputs may be provided to represent a CFE percentage target, an excess CFE percentage limit, and/or other goals of the optimization.

In some embodiments, inputs to the optimization engine 214 may include both historical information retrieved from the history data store 208 and future predicted information retrieved from the prediction data store 220. In this way, the optimization engine 214 may take into account weather predictions that may affect output from VRE sources, load predictions that may affect an amount of power needed by a consumer 102 or a cost thereof, PPAs and/or power generation capabilities offered by new power stations that are not yet available, and other factors in generating the optimal power purchasing strategy.

Outputs of the optimization engine 214 may include any suitable values that may be used by the consumer 102 to optimally obtain power from the grid 104. In some embodiments, the outputs may include an amount of power to obtain from each power station and/or dispatch amounts from each dispatchable asset per a schedule. Typically, the schedule may be provided in hour-by-hour increments. In some embodiments, the outputs may also include guidance for shifting load from one time increment to another time increment (e.g., from 11:00 AM to 9:00 PM), when possible. In some embodiments, the outputs may include indications of how much capacity should be built—for example, the outputs may indicate an optimal size for a local power storage system 106, considering a cost of building the local power storage system 106 and the benefit obtained therefrom. In some embodiments, the outputs may include strategies for charging/discharging a local power storage system 106 to augment power obtained from the grid 104.

To conduct the optimization, the optimization engine 214 minimizes a value of a suitable objective function. One suitable objective function is as follows:

Net spend=PPA cost−wholesale market revenue

The PPA cost refers to the cost to the consumer 102 for obtaining power from the grid 104. The wholesale market revenue refers to an amount of payments that the consumer 102 receives for power sent back to the grid 104 by the consumer 102, or on behalf of the consumer 102 by one or more power stations.

One will recognize that while the overall optimization objective is listed above as a simple function for the sake of clarity, each of the components of the function (e.g., the PPA cost and the wholesale market revenue) may represent a plurality of multiple functions and/or constraints that represent contributions of different actors to the net spend. In some embodiments, each power station on the grid 104 may be associated with corresponding cost functions and/or constraints that are components of the PPA cost and/or wholesale market revenue. Each cost function and/or constraint may flow through to the objective function to represent the overall problem to be optimized, and may include one or more decision variables of continuous values (e.g., an amount of power to obtain from a given power station) or integer variables (e.g., a Boolean value indicating whether or not to charge a battery) to be adjusted by the optimization engine 214 to minimize the value of the objective function and thereby find an optimal result.

In some embodiments, the PPA cost may be specified differently for different types of power stations. By modeling the costs of different types of power stations differently, a much more accurate representation of the costs can be considered by the optimization engine 214.

For example, the PPA cost for a VRE source such as solar power stations 114 or wind power stations 110 may be modeled as a fixed-for-floating PPA. A fixed-for-floating PPA is a cost model used for the contractual purchase of power from a power station, and is currently the most prevalent model for corporate purchasers of renewable energy in the United States from VRE sources. Under a fixed-for-floating PPA, for each interval or specified time period under the PPA (e.g., each hour) in which the VRE source produces power, a fixed payment to the VRE source from the consumer 102 is modeled that may be determined as a function of the amount of power generated by the VRE source and a fixed strike price, and a variable payment from the VRE source to the consumer 102 is modeled that may be determined as a function of the variable market price of power on the grid 104 and the amount of power produced by the VRE source during the interval or specified time period. In some embodiments, the fixed-for-floating PPA may be modeled as two payments for the sake of optimization, but in practice may be implemented as a virtual power purchase agreement (VPPA) in which there is a single net invoice per interval. By using a fixed-for-floating PPA, the hour-by-hour historical information and the hour-by-hour predicted information becomes increasingly important, in that the cost of the fixed-for-floating PPA can be more accurately predicted and considered during the optimization.

As another example, the PPA cost for a dispatchable asset such as a grid power storage station 116 may be modeled as a tolling contract. A tolling contract refers to an arrangement which is more akin to a lease than an indefinite quantity electricity supply contract. Under a tolling contract, the tolling operator sells the right to operate the capacity of a power station (or a fraction of the capacity of a power station) to a consumer 102 at a fixed price. The consumer 102 receives the right to use the power station or direct how the tolling operator operates the resource, and the associated economic cost and benefits of such use. Thus, the consumer 102 pays the tolling operator a fixed price for the capacity of the power station, and is also responsible for paying for inputs to the production of the power station, and in turn receives benefits and revenues that may be generated by the operation of the power station. In the case of a grid power storage station 116, the consumer 102 is typically responsible for paying the costs of power that is purchased to charge the grid power storage station 116, and receives any market revenues earned from the discharge of the grid power storage station 116.

The optimization engine 214 determines an optimal strategy for minimizing the value of the objective function subject to various constraints. For example, constraints may be used to represent the capabilities of each power station. A non-dispatchable power station may be represented by constraints such as a constraint that ensures that generation is equal to capacity multiplied by a normalized hour-by-hour profile without curtailment, and/or a constraint that a total installed capacity is smaller than a maximum capacity. A dispatchable power station such as a grid power storage station 116 may be represented by constraints such as a charge and discharge amount being less than an inverter size, a battery inverter size being smaller than a maximum capacity, a state of charge for a given hour being consistent with a state of charge from a previous hour plus or minus an amount of charge/discharge during the previous hour, a state of charge being less than a maximum charge capacity, and a number of charge/discharge cycles being less than a maximum number of charge/discharge cycles. A constraint that a battery may only be charged using available CFE may also be used. Storage power stations may be modeled assuming that they have perfect knowledge of hourly pricing of energy available on the grid 104.

Additional aspects may also be represented by constraints considered by the optimization engine 214. For example, a constraint may prevent simultaneous charge and discharge of a power storage system, another constraint may be used to require a desired percentage of CFE, and/or another constraint may be used to prevent violation of an excess CFE percentage. By using constraints for these values instead of representing them as penalty terms in the objective function, the optimization can converge faster and thereby require fewer computing resources to complete.

In some embodiments, the optimization engine 214 calculates the CFE percentage on an hourly basis as the output from CFE sources, plus the CFE percentage on the grid 104, multiplied by the remaining net load. The net load is equal to the load generated by the consumer 102 minus power generated by CFE sources plus dispatch from power storage systems, where the result is greater than or equal to zero. The CFE score is the sum of CFE across all hours, divided by the total load across all hours. Surplus CFE (CFE output greater than the load) does not contribute toward the CFE score.

In some embodiments, environmental characteristics of energy being obtained may be represented within the optimization as a cost or a constraint using renewable energy certificates (RECs). RECs represent proof that a given amount of electricity was generated from a renewable energy resource such as a CFE source and supplied to the grid 104. By representing RECs within the optimization, it can be certified that the amount of energy consumed from the grid 104 by the consumer 102 was supplied to the grid 104 by CFE sources.

At block 320, the consumer 102 manages power, including obtaining power from the plurality of power stations, according to the strategy determined by the optimization engine 214. This may include charging and discharging the local power storage system 106. In some embodiments, the consumer 102 may enter into PPAs, may configure switches or build transmission infrastructure to obtain power from given power stations, may trade RECs, or may otherwise manually or automatically obtain power per the hour-by-hour strategy provided by the optimization engine 214.

At block 322, a storage management engine 218 of the energy control computing system 210 controls charging and discharging of a local power storage system 106 according to the optimal power storage strategy determined by the optimization engine 214. In some embodiments, the optimization engine 214 provides the strategy for charging and discharging of the local power storage system 106 to a battery management system of the local power storage system 106, and the battery management system automatically controls the charging and discharging as instructed.

The method 300 then proceeds to an end block and terminates.

While illustrative embodiments have been illustrated and described, it will be appreciated that various changes can be made therein without departing from the spirit and scope of the invention. For example, the present disclosure references various data that is collected, predicted, and/or generated on an hourly basis. In some embodiments, other increments, including but not limited to one minute, five minutes, six minutes (0.1 hr), fifteen minutes (0.25 hr), daily, weekly, bi-weekly, monthly, or other increments, may be used for one or more collected, predicted, and/or generated values. Further, in some embodiments, an average of several increments may be combined into a single value.

The embodiments of the invention in which an exclusive property or privilege is claimed are defined as follows:

1. A computer-implemented method of optimizing power management for a consumer, the method comprising:
receiving, by a computing system, historical power generation and cost information for a plurality of power stations;
receiving, by the computing system, historical load information for the consumer;
generating, by the computing system, an optimal power management strategy based at least on the historical power generation and cost information for the plurality of power stations and the historical load information for the consumer, wherein the optimal power management strategy includes at least one of a distribution strategy, a storage strategy, or a usage strategy; and
causing, by the computing system, the consumer to manage power according to the optimal power management strategy.

2. The computer-implemented method of claim 1, wherein generating the optimal power management strategy includes generating a power management strategy that achieves a goal of obtaining power from power stations having desired characteristics while minimizing cost.

3. The computer-implemented method of claim 2, wherein the cost of the power management strategy includes an exchange of renewable energy certificates (RECs).

4. The computer-implemented method of claim 2, further comprising:
modeling cost of obtaining power from a first type of power station using a first technique; and
modeling cost of obtaining power from a second type of power station using a second technique different from the first technique.

5. The computer-implemented method of claim 2, wherein the power stations having desired characteristics are power stations that use carbon-free energy generation technologies.

6. The computer-implemented method of claim 1, wherein the optimal power management strategy includes the storage strategy and the distribution strategy; and wherein the method further comprises:
managing charging and discharging of a local power storage system according to the storage strategy.

7. The computer-implemented method of claim 1, wherein the optimal power management strategy includes identities of power stations to be used on an hour-by-hour basis.

8. The computer-implemented method of claim 1, further comprising predicting, by the computing system, future power generation and cost information for the plurality of power stations; and
wherein the generation of the optimal power management strategy is further based on the predicted power generation and cost information.

9. The computer-implemented method of claim 8, wherein the prediction of future power generation and cost information is based at least in part on a weather prediction.

10. The computer-implemented method of claim 8, wherein the predicted power generation and cost information includes information for at least one power station that has not yet been constructed.

11. The computer-implemented method of claim 1, wherein generating the optimal power management strategy includes solving an optimization problem using a mixed integer linear programming technique.

12. A non-transitory computer-readable medium having computer-executable instructions stored thereon that, in response to execution by one or more processors of an energy control computing system, cause the energy control computing system to perform actions for optimizing power management for a consumer, the actions comprising:
receiving, by the energy control computing system, historical power generation and cost information for a plurality of power stations;
receiving, by the energy control computing system, historical load information for the consumer;
generating, by the energy control computing system, an optimal power management strategy based at least on the historical power generation and cost information for the plurality of power stations and the historical load information for the consumer, wherein the optimal power management strategy includes at least one of a distribution strategy, a storage strategy, or a usage strategy; and
causing, by the energy control computing system, the consumer to manage power according to the optimal power management strategy.

13. The non-transitory computer-readable medium of claim 12, wherein generating the optimal power management strategy includes generating a power management strategy that achieves a goal of obtaining power from power stations having desired characteristics while minimizing cost.

14. The non-transitory computer-readable medium of claim 13, wherein the cost of the power management strategy includes an exchange of renewable energy certificates (RECs).

15. The non-transitory computer-readable medium of claim 13, wherein the actions further comprise:
modeling cost of obtaining power from a first type of power station using a first technique; and
modeling cost of obtaining power from a second type of power station using a second technique different from the first technique.

16. The non-transitory computer-readable medium of claim 13, wherein the power stations having desired characteristics are power stations that use carbon-free energy generation technologies.

17. The non-transitory computer-readable medium of claim 12, wherein the optimal power management strategy includes the storage strategy and the distribution strategy; and wherein the actions further comprise:
managing charging and discharging of a local power storage system according to the storage strategy.

18. The non-transitory computer-readable medium of claim 12, wherein the optimal power management strategy includes identities of power stations to be used on an hour-by-hour basis.

19. The non-transitory computer-readable medium of claim 12, wherein the actions further comprise:
predicting, by the computing system, future power generation and cost information for the plurality of power stations; and
wherein the generation of the optimal power management strategy is further based on the predicted power generation and cost information.

20. The non-transitory computer-readable medium of claim 19, wherein the prediction of future power generation and cost information is based at least in part on a weather prediction.
